(19) United States
(12) Patent Application Publication
(10) Pub. No.: US 2024/0389612 A1
(43) Pub. Date: Nov. 28, 2024

(54) WHOLE PLANT CANNABIS TEA WITH BIOAVAILABLE CANNABINOIDS

(71) Applicant: THE HEMP TEA COMPANY, LLC, Montpelier, VA (US)

(72) Inventors: Chad Currin, Glenville, NY (US); Thomas E. Gilardi, Montpelier, VA (US)

(73) Assignee: THE HEMP TEA COMPANY, LLC, Montpelier, VA (US)

(21) Appl. No.: 18/794,951

(22) Filed: Aug. 5, 2024

Related U.S. Application Data
(63) Continuation-in-part of application No. 18/534,272, filed on Dec. 8, 2023.
(60) Provisional application No. 63/530,649, filed on Aug. 3, 2023.
(60) Provisional application No. 63/431,232, filed on Dec. 8, 2022.

(30) Foreign Application Priority Data
Dec. 8, 2023 (WO) PCT/US2023/083204

(51) Int. Cl. A23F 3/34; A23F 3/22; A23F 3/32; A23F 3/40

(52) U.S. Cl. CPC A23F 3/34; A23F 3/225; A23F 3/32; A23F 3/405

(57) ABSTRACT

A composition of matter comprising a steepable organically based substance, such as a tea, as well as an apparatus and method of making the composition of matter is disclosed. In one embodiment, the composition of matter, apparatus and method are directed to a steepable organically based substance comprising an organic material, a lipid, and a powdered lipid. In certain embodiments, the organic material and lipids are mixed together, heated and agitated binding the lipid, such as an MCT oil, to the organic material and decarboxylating the compound. The decarboxylated compound is then cooled. The decarboxylated compound is then ground to a desired size (which in some embodiments may be as fine as a powder) which is then mixed with a powdered lipid, such as an MCT powder, to produce a steepable organic substance. In certain embodiments, the organic material comprises cannabis, and the steepable organic substance resulting from the disclosed process is a steepable cannabis tea.

### CROSS REFERENCE TO RELATED APPLICATIONS

This application claims priority to and the benefit of U.S. Provisional Patent Application Ser. No. 63/530,649, entitled “WHOLE PLANT CANNABIS TEA WITH BIOAVAILABLE CANNABINOIDS” filed Aug. 3, 2023, the entirety of which is incorporated herein by reference.

This application is also a continuation-in-part of and claims priority under 35 U.S.C. § 120 from copending U.S. patent application Ser. No. 18/534,272, filed on Dec. 8, 2023, entitled “EDIBLE CANNABIS PLANT POWDER,” which claims priority to and the benefit of U.S. Provisional Patent Application Ser. No. 63/431,232, entitled “EDIBLE CANNABIS PLANT POWDER” filed Dec. 8, 2022, the contents of each of which are hereby incorporated herein by reference in their entireties.

This application is also a continuation-in-part of and claims priority under 35 U.S.C. § 119 from copending International Patent Application No. PCT/US23/83204 filed on Dec. 8, 2023, under the Patent Cooperation Treaty entitled “EDIBLE CANNABIS PLANT POWDER,” which claims priority to and the benefit of U.S. Provisional Patent Application Ser. No. 63/431,232, entitled “EDIBLE CANNABIS PLANT POWDER” filed Dec. 8, 2022, the contents of each of which are hereby incorporated herein by reference in their entireties.

### FIELD OF THE DISCLOSURE

The present embodiments are generally directed to organic materials for human ingestion. Such embodiments may include but not be limited to steepable organics which are processed in such a manner that the person consuming such organics receive some or all of the beneficial components of the organic when the organic is steeped, drunk and/or otherwise ingested. As used herein, the term “steepable” refers to a characteristic of the particular organic in question which enables the organic or by-product of the organic to be steeped or soaked in a liquid to achieve a desired concentration of the organic and/or by-product in the liquid. The embodiments further disclose methods and apparatus for processing such organics and the manner for using such processed organics to achieve the intended health, nutritional and other benefits of ingesting the organic in liquids, such as, for example, tea.

### BACKGROUND

Man has long sought to reap, and maximize, the health and nutritional benefits from various organic materials found in nature. One such organic which has been closely studied for its wide-ranging health and nutritional benefits is the cannabis plant.

One of the oldest means used to derive at least some of the benefits from the cannabis plant involves smoking cannabis plant material. However, such means of consumption also introduces certain health risks associated with smoking.

Another means to derive certain benefits from the cannabis plant involves ingesting edible forms of the cannabis plant material, extracts and/or components of the cannabis plant material. However, existing edibles typically include highly processed cannabinoid oils which are lacking cannabinoid diversity, terpenes, and other beneficial components of the cannabis plant.

Typically, humanly consumable edibles derived from certain organic materials are made by chemical or solvent extraction. In the case of the cannabis plant as the organic, certain cannabinoids including, but not limited to Tetrahydrocannabinol (“THC”), Cannabidiol (“CBD”), and/or other major and/or minor cannabinoids, are extracted from the cannabis plant material by chemical or solvent extraction. The extracted cannabinoids are then highly processed to isolate the extracted materials from the cannabis plant itself and converted into a form that is shelf-stable and can be processed by human digestion. However, though various cannabinoid extraction processes currently exist, no such process allows for the separation or isolation of cannabinoids from the cannabis plant without the use of chemical or solvent extraction methods resulting in edible materials which may provide a wide spectrum of health, nutritional and other benefits realized through the human consumption of such edible materials.

Moreover, in the case of steepable organics, many cannabis teas are made by dropping extracted, purified and winterized THC oil onto the tea material requiring many more steps to deliver an inferior product. By using these methods, users only get the THC component of the cannabis while other beneficial components available in the cannabis are not introduced. Moreover, as an oil, the THC does not mix with the water in the tea and tends to sit on the surface of the liquid rather than staying in solution.

Prior methods require curing an organic plant material, using expensive solvent-based extraction methods, mixing the organics with a carrier oil, then adding by way of a dropper the resulting composition to tea, herbal beverage, or other consumable. When employing these methods, dosing may be difficult thereby making the resulting effects of the dosing unpredictable. Current methods also do not solve the hydrophobic nature of THC alone or in a carrier oil. Using such prior methods, the THC or THC/Carrier oil combination remains hydrophobic and sits on top of the tea water.

Accordingly, there exists a need for steepable organics which are processed in such a manner that the person consuming such organics receive some or all of the beneficial components of the organic when the organic is steeped, drunk and/or otherwise ingested.

### SUMMARY OF THE INVENTION

The present invention relates to processes, methods and apparatus for producing edible compositions from organic materials and the compositions derived therefrom. In one embodiment, the invention relates to a process, method, and apparatus for producing and using an edible whole plant powder from a cannabis plant and compositions derived therefrom.

In one embodiment, a steepable and/or edible organically based powder comprising an organic material, a lipid, such as for example, MCT (medium-chain triglyceride) oil which may comprise medium-chain triglycerides, and MCT oil powder. In certain embodiments, the organic material and lipids are mixed together, heated and constantly agitated while heating, and agitated while cooled. The organic material and dried lipids are then ground to a desired size (which in some embodiments may be as fine as a powder) which is then mixed with the lipid powder (also referred to herein as “Lipid Powder”) to produce the edible and/or steepable organic substance.

In another embodiment, the organically based material comprises cannabis and the resulting edible organic and/or steepable substance is an edible cannabis plant powder, and in some embodiments a steepable tea. Generally, cannabis tea may comprise cannabis processed in a way that allows for the cannabis to be steeped in water a makes the cannabis bioavailable

In certain embodiments the dehydrated materials may comprise various combinations including but not limited to: (i) an organic and a fat; or (ii) an organic and a lipid; or (iii) an organic and a lipid powder.

In certain embodiments one or more of the dehydrated material combinations may then be combined with a fat, a lipid, a lipid powder, an MCT Powder, or other suitable substance to produce the desired edible and/or steepable organic substance.

Generally, the fats used in certain embodiments are both hydrophilic and hydrophobic, such as lipids, allowing the molecules of the various components to bond with both oil and water. Either liquid lipids, such as by non-limiting example MCT coconut oil, and/or powdered lipids may be used. In some embodiments, powered lipids substantially homogeneously combine with the dehydrated material and substantially coat the dehydrated material.

In some embodiments, producing teas from the compounds and/or processes disclosed herein, the hydrophilic and hydrophobic characteristics of the lipids, such as by non-limiting example MCT powder, enable the oil-based compounds to combine with water instead of separating from the water and floating to the surface.

While, generally, the finished product such as edible and/or steepable organic powder and/or tea disclosed herein does not substantially dissolve in water, certain lipids bound to the organic material, such as by non-limiting example cannabinoids, and other ingredients may be substantially water soluble.

In certain embodiments, certain finished product such as edible and/or steepable organic powder and/or tea disclosed herein may be finished with one or more of lipid powder and/or mixed with traditional teas, flavors, herbs, spices and or other components.

In yet another embodiment, a process for making an edible and/or steepable organic powder and/or tea is disclosed. In one embodiment of the process comprises the steps of mixing together the organic material and MCT oil, heating the organic material and MCT oil mixture in a convection oven which is capable of decarboxylating the mixture while heating, agitating the organic material and lipid mixture while heating, cooling the organic material and lipid mixture after heating, grinding the cooled organic material and lipid mixture into a desired size (which in some embodiments may be as fine as a powder), and mixing the ground organic material and lipid mixture with an MCT oil powder to produce the edible and/or steepable organic substance.

In another embodiment of the process disclosed herein, the organically based material used in the process comprises cannabis and the resulting edible and/or steepable organic substance resulting from the process is an edible and/or steepable cannabis plant powder the benefits of which may be transferred to heated, room temperature or cooled water by steeping by itself or mixed with teas, herbs, and/or similar components.

Moreover, in using certain embodiments of the methods disclosed herein, the cannabinoids which are hydrophobic are bound to lipids which are both hydrophobic and hydrophilic. Accordingly, the cannabinoids present in whole plant cannabis tea may be suspended in water making them bioavailable to the user. Inasmuch as cannabis and cannabinoids are hydrophobic and do not mix with water, certain methods disclosed herein allow for the bioavailability of cannabinoids and other plant benefits when steeped in water.

### BRIEF DESCRIPTION OF THE DRAWINGS

The accompanying drawings, diagrams, figures and/or Appendices, which are included to provide a further understanding of the invention and are incorporated in and constitute a part of this specification, illustrate embodiments of the invention and together with the description serve to explain the principles of the invention, in which like numerals refer to like components or steps, and wherein:

FIG. 1 is a flow diagram illustrating an embodiment of the process for making a steepable organic powder of the present invention wherein the raw organic material comprises a cannabis plant material which is bound with a lipid during decarboxylation.

FIG. 2 is an image of finished material of one embodiment with an herbal blend.

APPENDIX A comprises pages from a testing laboratory report which confirms the composition of a sample of one embodiment of a finished edible and/or steepable cannabis powder produced by process disclosed herein.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in a typical inventory tracking system. Those of ordinary skill in the pertinent art may recognize that other elements may be desirable and/or required in order to implement the present invention. However, because such elements are well known in the art, and because they do not facilitate a better understanding of the present invention, a discussion of such elements is not provided herein.

Reference will now be made in detail to several exemplary and non-limiting embodiments of the present invention, some of which are illustrated in the accompanying drawings.

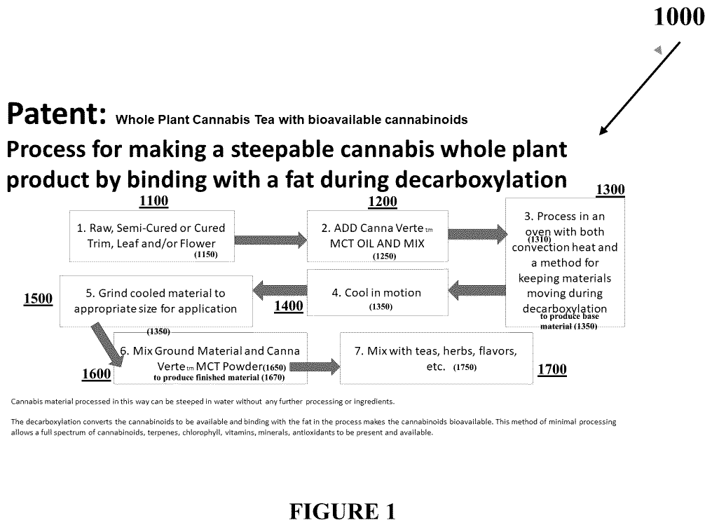

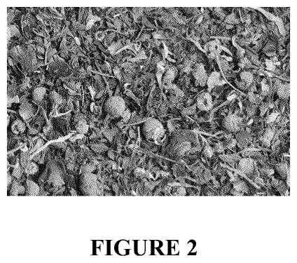

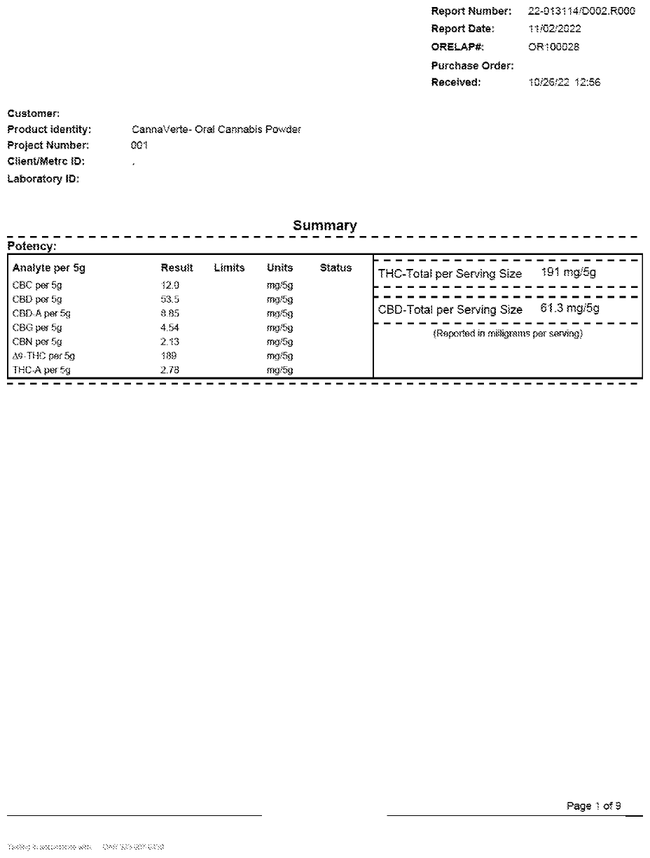

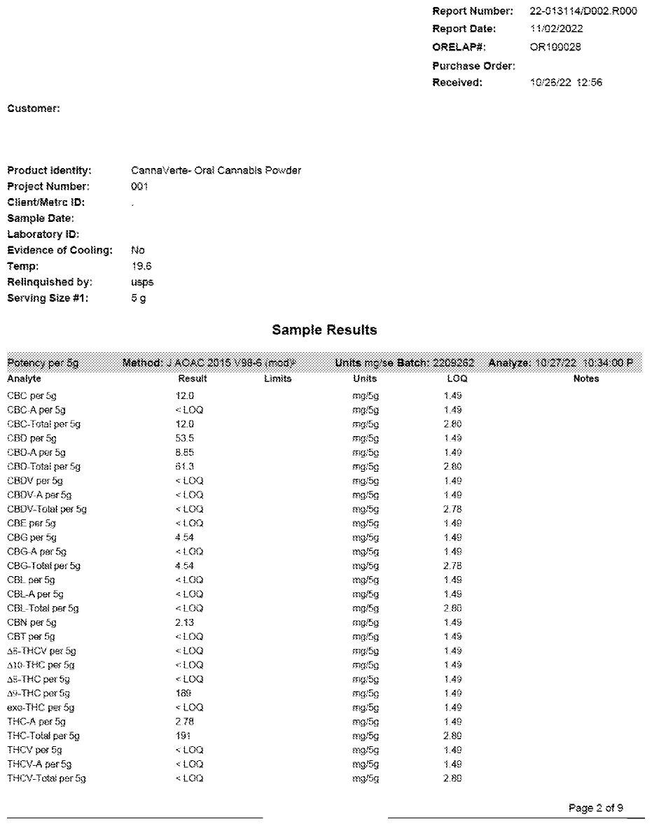

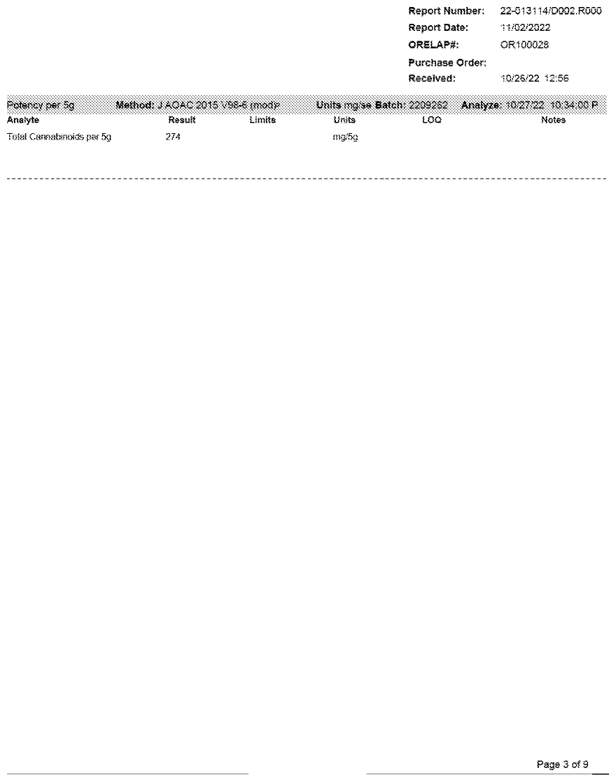

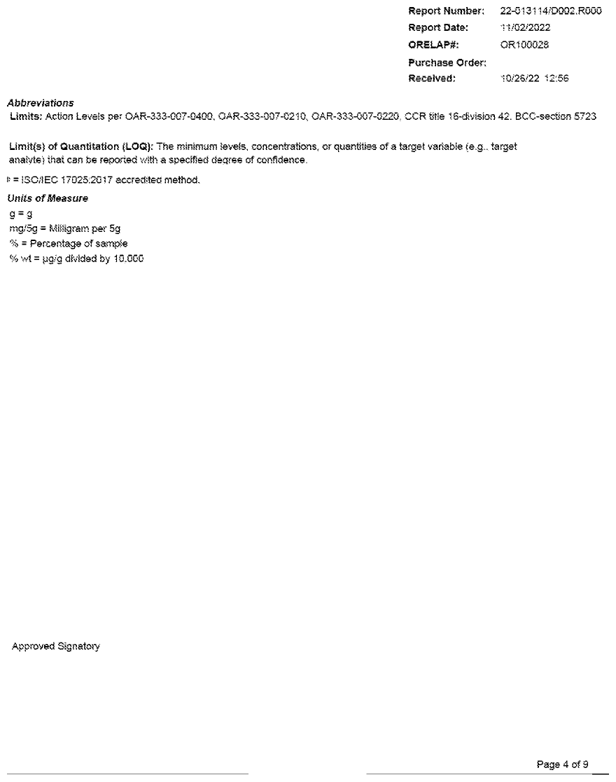

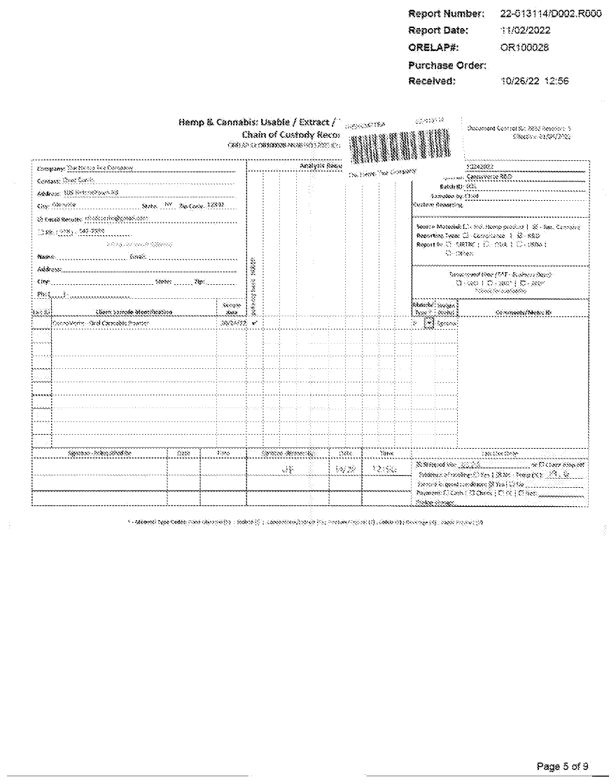

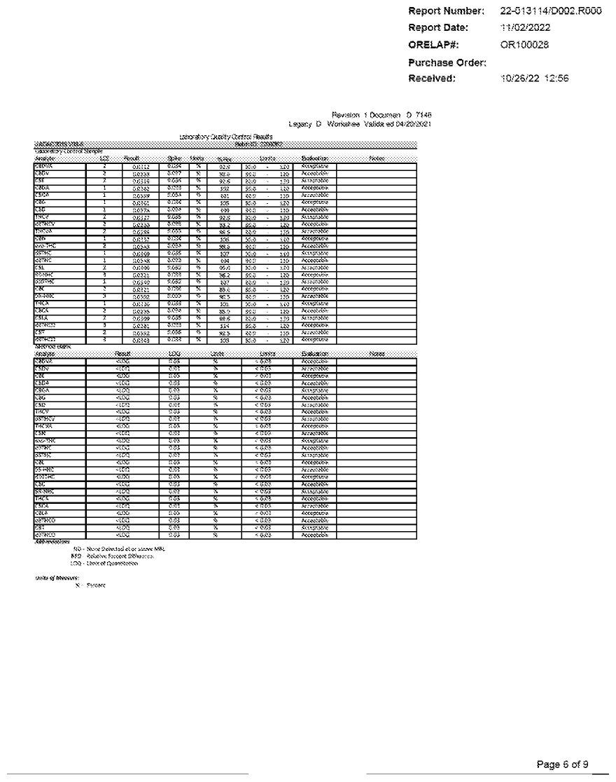

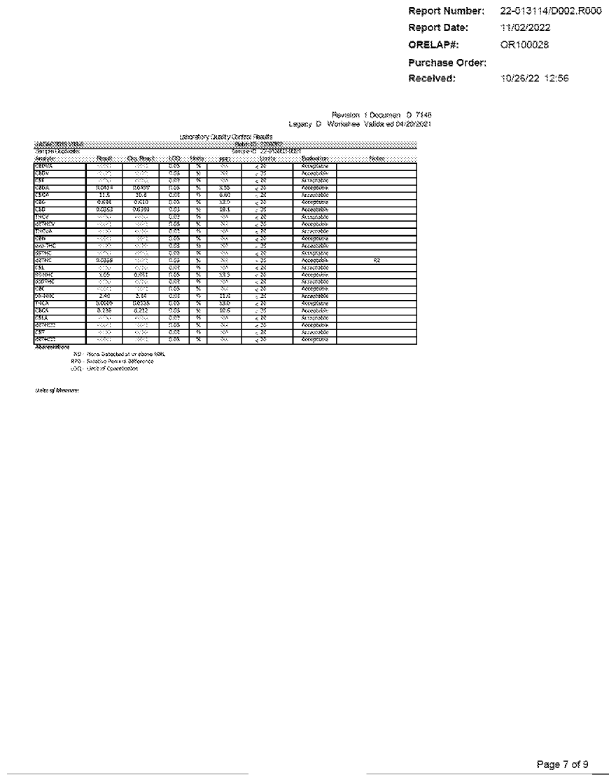

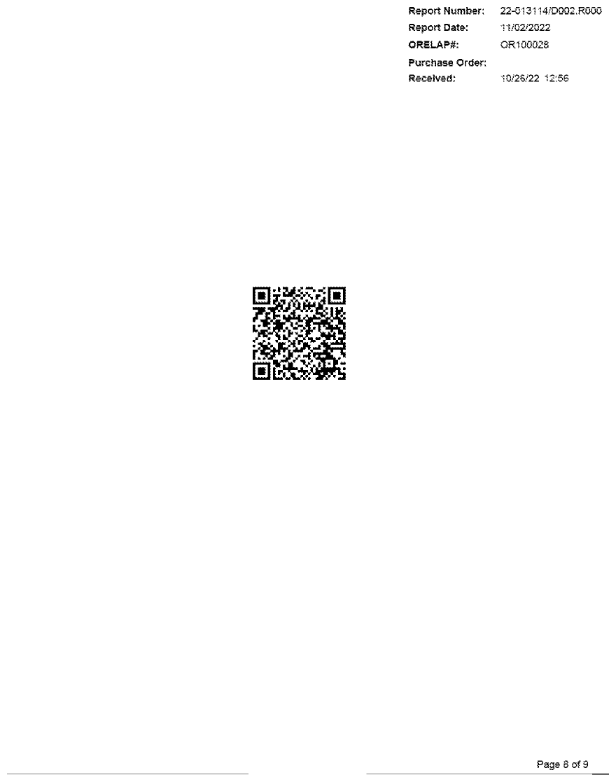

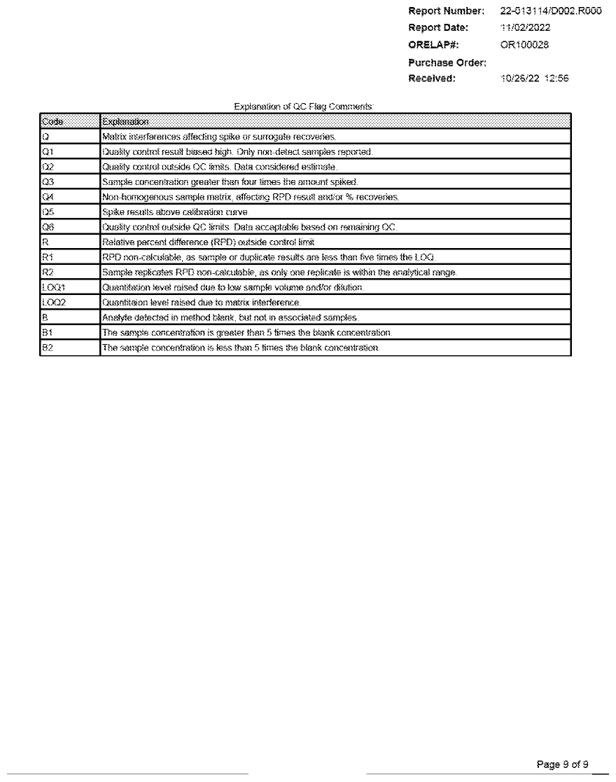

Turning now to FIG. 1, there is shown a process flow diagram depicting an embodiment of the method and/or process 1000 of the present invention. In particular, this embodiment of process 1000 depicts one method for making a steepable cannabis plant product by binding an organic material with a fat during decarboxylation.

Process 1000 begins with preparation 1100 of raw organic material 1150 such as for example raw cannabis, shucked cannabis, cannabis leaf, cannabis flower and/or semi-cured or cured cannabis trim.

At 1200, between about ½% to about 1% by mass of lipid 1250, such as liquid or powdered MCT oil, which MCT oil may typically comprise medium-chain triglycerides, is added to raw material 1150.

At 1300, the combined raw material 1150 and lipid 1250 are placed and mixed in dehydrator 1310. Dehydrator 1310 is capable of heating and keeping raw material 1150 and lipid 1250 in motion during process 1000, which generally causes the decarboxylation of raw material 1150 and lipid 1250. In certain embodiments, dehydrator 1310 functions with one or more characteristics of a sealed convection oven and/or a food waste dehydrator. In one embodiment, dehydrator 1310 may comprise a dehydrator manufactured by ENIC, Model Ecovim Eco-66, which uses a combination of convection heating and air flow which results in the decarboxylation of raw material 1150 and lipid 1250.

During step 1300, raw materials 1150 and lipid 1250 are processed by heating and mixing in dehydrator 1310 for approximately one hour while gradually increasing the heat in convection oven 1310 to between about 83° C. and 90° C. In certain embodiments, maintaining the heat in dehydrator 1310 containing raw materials 1150 and lipid 1250 for approximately fifteen (15) minutes at the highest level of the heat range may be preferred. Optimal heating duration for any given raw material 1150 and lipid 1250 mixture, in part, may depend upon the actual moisture content of raw material 1150. Typically, however, many raw materials 1150 and lipid 1250 mixtures require approximately a minimum of one (1) hour of heating and mixing in dehydrator 1310 and/or at least until a desired moisture level is achieved. An acceptable moisture level in raw material 1150 and lipid 1250 mixture may typically be about 5% by mass, however moisture levels in certain embodiments of between about 3% and about 8% by mass may also be acceptable.

Typically, steps 1200 and 1300 bind lipid 1250 (such as, by non-limiting example, MCT oil 1250) to raw material 1150 and decarboxylates raw material 1150. In the case where raw material 1150 is cannabis, decarboxylation generally converts the major and minor phytocannabinoids (e,g, THC-A and CBD-A, respectively) in cannabis 1150 into active molecular forms (e.g. THC-A in cannabis 1150 and THC in the base material 1350 ultimately produced from process 1000) which may influence a human's neurotransmitters.

In certain embodiments, the decarboxylation process converts the cannabinoids present in raw organic material 1150 such that the cannabinoids are made available to bind with lipid 1250 during process 1000, and/or making the cannabinoids bioavailable in products produced by process 1000. In addition, in certain embodiments, process 1000 may allow for a full spectrum of certain cannabinoids, terpenes, chlorophyll, vitamins, and/or antioxidants to be present and available in products produced by process 1000.

Once the mixing 1200 and processing 1300 steps are completed, raw material 1150 and lipid 1250 mixture may be cooled by cooling process 1400, which results in the production of base material 1350.

In certain embodiments, cooling process 1400 may comprise continuous tumbling, mixing or other motion, and/or may cool raw material 1150 and lipid 1250 mixture to a temperature of about 20° C. or about room temperature. Such substantially continuous motion during process 1000 may assist in minimizing, and preferably preventing, raw material 1150 and lipid 1250 mixture and/or base material 1350 from coming in contact with or otherwise touching the heat source introduced at step 1300, and/or from burning.

Once base material 1350 is sufficiently cooled at 1400, base material 1350 may be ground at 1500 into an appropriate size 1550, which may be any size appropriate for the intended use of the product produced by process 1000. In one embodiment, base material 1350 may be ground 1500 into powder 1550 such as, for example, a powder 1550 to suit the product to be produced by process 1000. In certain embodiments, base material 1350 may be ground 1500 into an appropriate particle size 1550 which promotes steeping in a liquid and/or the rapid and/or efficient ingestion, absorption and/or other processing by the human body. Additionally, or alternatively, in certain embodiments, base material 1350 may be ground 1500 to an appropriate particle size 1550 which maximizes the beneficial characteristics of the product produced by process 1000 to be realized from the steeping in a liquid and/or the ingestion, absorption and/or other processing by the human body of the product produced by process 1000. For example, such beneficial characteristics may include, but not be limited to, health, nutritional and other benefits.

Once ground material 1550 has been ground to the desired size at 1500, ground material 1550 may be mixed at 1600 with at least approximately 10% by mass of powdered MCT oil 1650. In certain embodiments, ground material 1550 may be mixed at 1600 with between about 15% and about 50% or more by mass of powdered MCT oil 1650 to produce finished material 1670.

In certain embodiments, varying the amount of powdered MCT oil 1650 added to ground material 1550 may increase or decrease the steeping characteristics and/or the digestibility of finished material 1670. In addition, or alternatively, in certain embodiments, varying the amount of powdered MCT oil 1650 added to ground material 1550 may increase or decrease the uptake “ability and speed” realized from the steeping of and/or ingestion, absorption and/or other processing by the human body of finished material 1670. In certain embodiments, adding above about 15% by mass of powdered MCT oil 1650 added to ground material 1550 may be used to control dosage and/or maximize THC levels in finished material 1670.

After mixing ground material 1550 with appropriate amount of powdered MCT oil 1650 at 1600 to produce finished material 1670, finished material 1670 may be used for the steeping of, and/or ingestion, absorption and/or other processing by the human body, including but not limited to, a steepable and/or edible tea alone and/or mixed with other ingredients. In certain embodiments, finished material 1670 may be in the form of a steepable tea or edible powder 1670.

The characteristics of finished material 1670 may be varied as different types and varying amounts of raw organic materials 1150, fats 1250, and/or lipid powders 1650 are used in process 1000. The characteristics of finished material 1670 also may be varied as different heating and cooling temperatures and durations, agitation speeds and durations are employed in process 1000.

In one embodiment, where cannabis is used as raw organic material 1150 in process 1000, resulting finished material 1670 may have a higher concentration of THC and/or lesser or no amounts of CBD.

In another embodiment, where hemp is used as raw organic material 1150 in process 1000, resulting finished material 1670 may have a higher concentration of CBD and/or lesser or no amounts of THC.

In yet other embodiments, lipids 1250 may be increased, alternative lipids 1250 to MCT oil 1250, such as by non-limiting example sunflower lecithin may be employed, and/or lipids 1650 used post decarboxylation may be increased, decreased, or otherwise changed.

At, 1700, finished material 1670 may be packaged and ingested as a steepable tea, a ready-to-eat product itself, sprinkled on food, and/or mixed into a beverage such as a smoothie. In addition, at 1700, finished material 1670 may be combined with one or more of traditional teas, herbs, flavors, and/or spices to make tea with bioavailable cannabis based ingredients.

Finished material 1670 may also be mixed with other organics, compositions, and/or products such as CBD, echinacea, probiotics and the like, in order to meet the intended end characteristics of finished material 1670.

In certain embodiments, raw organic material 1150, and particularly cannabis material, processed in accordance with the disclosure herein, may be orally ingested by humans without further processing or ingredients.

Appendix A hereto comprises a testing laboratory report which confirms the composition of a sample of one embodiment of finished cannabis powder 1650 produced by process 1000 disclosed herein.

In this embodiment, approximately six (6) lbs (approximately 2750 grams) of cannabis trim and flower 1150 were prepared at 1100 and mixed at 1200 with approximately thirty (30) grams of MCT powder 1250 to form a cannabis 1150 and MCT powder 1250 mixture. In this embodiment, MCT powder 1250 comprised GARDEN OF LIFE brand coconut MCT powder which comprises 100% coconut derived kosher, food grade, vegan, non-GMO fractionated coconut oil.

The combined cannabis material 1150 and MCT powder 1250 was then placed in dehydrator 1310 and heated and mixed for approximately one (1) hour and five (5) minutes by gradually increasing the heat to a maximum of about 90° C.

The cannabis material 1150 and MCT powder 1250 mixture was then cooled to approximately 20° C. by tumbling the cannabis 1150 and MCT powder 1250 mixture in dehydrator 1310 to produce base material 1350.

Base material 1350 was then ground into ground cannabis powder 1550.

Ground cannabis powder 1550 was then mixed with approximately 15% certified organic, vegan, keto certified, paleo certified, non-GMO, MCT oil powder obtained from GARDEN OF LIFE® (www.gardenoflife.com) to form finished cannabis powder 1650.

A sample of finished cannabis powder 1650 was then analyzed to determine the composition of finished cannabis powder 1650. The results of the composition analysis of the sample of finished cannabis powder 1650 are set forth in Appendix A hereto.

The disclosure herein is directed to the variations and modifications of the elements and methods of the invention disclosed that will be apparent to those skilled in the art in light of the disclosure herein. Thus, it is intended that the present invention covers not only the embodiments which are disclosed herein but also all modifications and variations of those embodiments and all equivalents thereof.

1. A steepable organically based substance comprising:
an organic material; and
a lipid;
wherein said organic material and lipid are mixed together, heated and agitated while heating to produce a base material, wherein said base material is cooled, wherein said base material is then ground to a desired size to produce a ground base material, and wherein said ground base material is then mixed with a powdered lipid to produce said steepable organic substance.

2. The steepable organically based substance of claim 1, wherein said organic material comprises cannabis.

3. The steepable organically based substance of claim 1, wherein said lipid comprises an MCT oil.

4. The steepable organically based substance of claim 1, wherein said powdered lipid comprises MCT powder.

5. The steepable organically based substance of claim 1, wherein said steepable organic substance comprises a tea.

6. The steepable organically based substance of claim 1, further comprises one or more of traditional teas, herbs, flavors, and spices.

7. A process for making a steepable organic substance comprising the steps of:
mixing together an organic material and a lipid to form an organic material and lipid mixture;
heating and agitating said organic material and lipid mixture in a dehydrator which is capable of decarboxylating said organic material and lipid mixture while heating and agitating produce a base material;
after said heating and agitating, cooling said base material;
after said cooling, grinding said base material into a desired size to produce a ground base material; and
after said grinding, mixing said ground base material with a powdered lipid to produce said steepable organic substance.

8. The process for making said steepable organic substance of claim 7, wherein said organically based material comprises cannabis.

9. The process for making said steepable organic substance of claim 7, wherein said lipid comprises an MCT oil.

10. The process for making said steepable organic substance of claim 7, wherein said powdered lipid comprises MCT powder.

11. The process for making said steepable organic substance of claim 7, wherein said steepable organic substance comprises a tea.

12. The process for making said steepable organic substance of claim 7, wherein said steepable organic substance further comprises one or more of traditional teas, herbs, flavors, and spices.
